(19) United States
(12) Patent Application Publication
(10) Pub. No.: US 2014/0157377 A1
(43) Pub. Date: Jun. 5, 2014

(54) SYSTEM FOR REDUCING AN ONLINE USER'S INFORMATION BURDEN FOR ONLINE PROFILES

(71) Applicant: 1Site1Login, Inc., Jersey City, NJ (US)

(72) Inventors: Rita Kiryakos, Jersey City, NJ (US); John Louf, Glendale, AZ (US); Frank Pinal, Weehawken, NJ (US)

(73) Assignee: 1Site1Login, Inc., Jersey City, NJ (US)

(21) Appl. No.: 14/093,621

(22) Filed: Dec. 2, 2013

Related U.S. Application Data
(60) Provisional application No. 61/733,092, filed on Dec. 4, 2012.

(51) Int. Cl. G06F 21/31

(52) U.S. Cl. CPC G06F 21/31
USPC 726/5

(57) ABSTRACT

A method and system for managing online profiles. The method comprises receiving a plurality of online profiles of a user, the plurality of online profiles including login parameters for websites, and storing the plurality of online profiles in an account associated with the user. The method further comprises receiving a request to navigate to a given one of the plurality of online profiles associated with a given website, retrieving a webpage corresponding to the given website, and loading the given online profile to the webpage corresponding to the given website.

### CLAIM OF PRIORITY

This application claims the priority of U.S. Provisional Application No. 61/733,092, entitled “SYSTEM FOR REDUCING AN ONLINE USER'S INFORMATION BURDEN FOR ONLINE PROFILES,” filed on Dec. 4, 2012, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The invention described herein generally relates to storing and retrieving profiles associated with a plurality of websites.

2. Description of the Related Art

The World Wide Web offers a diverse pool of social media and gaming sites in which users from every corner of the world can plug and play. The advent of mobile devices in the past decade has promoted the rapid growth of social media network websites, making it easier for users to connect with each other while on the road. The tremendous increase in social media and gaming sites has led to a vast number of diversified sites, each dedicated to its own niche market in order to satisfy the various tastes of the user. Each website requires the user to setup a new username and password which leaves the user with an overwhelming amount of information to retain. In order to better simplify a user's online experience, there needs to be a website that allows the user to only enter one user name and one password and that, thereby, grants the user access to all of his or her online profiles.

### SUMMARY OF THE INVENTION

The present invention described herein provides a method, system and computer readable media for managing online profiles whereby an internet user can manage and keep track of his or her usernames and passwords. The method comprises receiving a plurality of online profiles of a user, the plurality of online profiles including login parameters for websites, and storing the plurality of online profiles in an account associated with the user. The method further comprises receiving a request to navigate to a given one of the plurality of online profiles associated with a given website, retrieving a webpage corresponding to the given website, and loading the given online profile to the webpage corresponding to the given website.

In one embodiment, receiving the plurality of online profiles includes receiving usernames and passwords for specific websites. A plurality of websites may be provided to the user to link with the login parameters. According to another embodiment, loading the given online profile to the webpage includes populating login parameters from the given online profile to the webpage.

The system comprises a processor and a memory having executable instructions stored thereon. The executable instructions that when executed by the processor cause the processor to receive a plurality of online profiles of a user, the plurality of online profiles including login parameters for websites, store the plurality of online profiles in an account associated with the user, receive a request to navigate to a given one of the plurality of online profiles associated with a given website, retrieve a webpage corresponding to the given website, and load the given online profile to the webpage corresponding to the given website.

In one embodiment, the processor is configured to receive usernames and passwords for specific websites. The processor may also be configured to provide a plurality of websites to link with the login parameters. In another embodiment, the processor is configured to populate login parameters from the given online profile to the webpage.

The computer readable media comprises program code that when executed by a programmable processor causes execution of a method for managing online profiles. The computer readable media comprises computer program code for receiving a plurality of online profiles of a user, the plurality of online profiles including login parameters for websites, computer program code for storing the plurality of online profiles in an account associated with the user, computer program code for receiving a request to navigate to a given one of the plurality of online profiles associated with a given website, computer program code for retrieving a webpage corresponding to the given website, and computer program code for loading the given online profile to the webpage corresponding to the given website.

In one embodiment, the computer program code for receiving the plurality of online profiles includes computer program code for receiving usernames and passwords for specific websites. The computer readable media may further comprise computer program code for providing a plurality of websites to link with the login parameters. In another embodiment, the computer readable media the computer program code for loading the given online profile to the webpage may include computer program code for populating login parameters from the given online profile to the webpage.

According to embodiments of the present invention, a website or program with one username and one password may store data for accessing target websites, including but not limited to social media, gaming, music, e-commerce websites, etc., of which the user is already a current member. The website or program populates the user's stored passwords automatically as a browser calls on a target website(s). The user accesses the website or program with the username and password. After doing so, the website or program provides the user with links to any of an unlimited number of target websites. The user can then selectively choose which target websites or links to target websites he or she may choose to interface with on the website or program by entering his or her profile information and activating said link or target websites.

In at least a first embodiment, a device with a microprocessor and with web browsing capabilities will send a request to the website or program server via an internet protocol; may it be hyper text transfer protocol or some other. Upon fulfillment of this request, and using a hypertext markup language construct, the web browser may present a login comprised of a username and a password. Upon submittal of the user form information, a server side program will send the given parameters to a database platform which will in turn validate the information that has been submitted. Once validation has been completed a user will have instant access to all of his or her online profiles. Usernames and passwords for various profiles may be submitted by the user and stored in a database platform and may be retrieved via a server side program when requested by the browser. At the request of a profile and its uniform resource locator and depending on whether or not the user has a web browser plug-in or standalone program containing a web browser, the user will either be directed to another webpage while still signed into the website or program server or the browser's target may be the current window.

In at least a second embodiment, a system can also be accomplished by means of a computer programming language in which algorithms construct a standalone program capable of storing, fetching, and receiving a user's online profile(s). In context, herein, a programming language is one that has the capabilities of expressing all possible algorithms, and a standalone program is an algorithm or set of instructions which are dependent upon no other environment other than itself, e.g., an application program. Such a system accomplishes the same result, but with less dependency on server side scripts, relational database management systems, servers, or websites containing a user interface, etc.

In at least a third embodiment, another means of accomplishing the system disclosed herein; would be to rely extensively on client side scripting languages, including but not limited to JavaScript, VBScript, PerlScript, etc. In this context, the client side program would execute on the client computing device, granting the user access to all of his or her online profiles. Such a system accomplishes the same result, but with less dependency on server side scripts or a relational database management system.

### BRIEF DESCRIPTION OF THE FIGURES

The invention is illustrated in the figures of the accompanying drawings which are meant to be exemplary and not limiting, in which like references are intended to refer to like or corresponding parts, and in which:

FIG. 1 illustrates a computing system according to a first embodiment of the present invention;

FIG. 2 illustrates a computing system according to a second embodiment of the present invention;

FIG. 3 illustrates a computing system according to a third embodiment of the present invention;

FIG. 4 illustrates a flowchart of a method for storing online profiles associated with a plurality of websites according to an embodiment of the present invention; and

FIG. 5 illustrates a flowchart of a method for loading online profiles according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

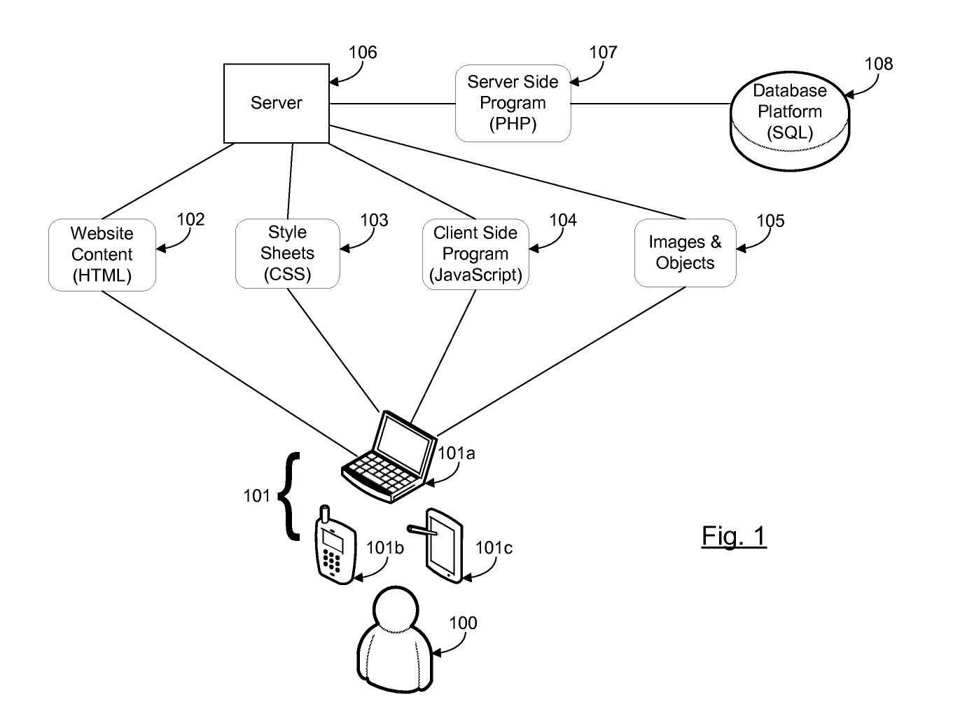

The present invention described herein provides a method whereby an internet user can keep track and manage his or her usernames and passwords. According to embodiments of the present invention, a website or program with one username and one password may store data for accessing target websites, including but not limited to social media, gaming, music, e-commerce websites, etc., of which the user is already a current member. Referring to FIG. 1, according to at least the first embodiment of the invention, the system 130 disclosed herein includes at least one user 100 and a client computing device 101, including but not limited to a laptop computer 101a, a mobile device 101b, 101c such as a smart phone 101b or tablet 101c, etc. A client computing device 101 in this context is any physical object containing a microprocessor and a memory unit with the capability to access the internet through means of a browser, whether the browser is a standalone browser or part of a larger program that includes a browser. A client computing device 101, 101a, 101b, 101c may also have the capabilities to fetch, receive, and decode information from a server 106 via an internet protocol such as but not limited to hyper text transfer protocol (HTTP), File Transfer Protocol (FTP), Transfer Control Protocol and Internet Protocol (TCP/IP), etc.

A server 106 may be configured to host various different programs in which the client computer 101, 101a, 101b, 101c may request in order for the user 100 to access all of his or her online profiles. A request is made to the server 106 by the web browser of the client computer 101, 101a, 101b, 101c; this request is submitted via a user form that can be accessed by the client computer 101, 101a, 101b, 101c by means of a website 102 with a specific uniform resource locator. The website 102 in context may be hosted on server 106. Once a request has been made by the web browser of the client computer 101, 101a, 101b, 101c to the server 106 via a user form on the website 102, a server side program 107 may work to validate the submitted user form. There are many server side programming languages that may be used, such as but not limited to PHP: Hypertext Preprocessor programming, ASP, ASP.NET, Cold Fusion, Perl, Python, Server-side JavaScript, etc. Upon validation of the parameters submitted within the user form, the server side program 107 may retrieve the user's 100 specific information which may be stored on a database 108. The database 108 can be created and managed by a query language, such as but not limited to SQL, XQuery, QUEL, D, etc., or any other special-purpose programming language which is intended for managing data in relational database management systems.

A user interface made available via a website 102, hosted by a server 106, is comprised of a markup language which may include, but is not limited to a hyper text markup language, such as but not limited to HTML, XML, XHTML, WML, DHTML, etc. The markup language may serve to provide structure for the given elements that compose of the website 102, while a style sheet language such as but not limited to Cascading Style Sheets (CSS), Document Style and Semantics and Specification Language (DSSL), Extensible Style sheet Language (XSL), JavaScript Style Sheets (JSSS), etc., style sheets 103 may provide the website 102 with the formatting of these various elements. A client side program 104 comprised of but not limited to JavaScript, VBScript, PerlScript, etc., may serve to enhance user interactivity and form validation via the website 102. Source code for the markup language, style sheets 103, and client side program 104 may be hosted on at least one server 106, presented via the means of a website, and executed on the client computer 101, 101a, 101b, 101c web browser.

The user interface may be comprised of either a static webpage, which is a webpage presented to the user 100 through the computing device's 101, 101a, 101b, 101c web browser without change in all instances, or a dynamic webpage, which is a webpage that is also presented to the user 100 through the computing device's 101, 101a, 101b, 101c web browser but generated at the time of request by the browser. Thus, depending upon the user's 101, 101a, 101b, 101c interaction with the interface, the webpage may or may not change upon every instance of its request. To generate a dynamic webpage that a user will interface with, a web application is hosted on the server 106 and may be constructed by means of a server side programming language 107, PHP: Hypertext Preprocessor programming, ASP, ASP.NET, Cold Fusion, Perl, Python, Server-side JavaScript, etc.

Images & objects 105 include other materials comprised of pictures, videos, sound files, and such that support the construction of the website 102. For purposes of a more readily available webpage, images & objects 105 may be stored on the same host server 106 as the server side program 107 and the database 108; however, this is subject to the architecture set forth by the web developer and these images & objects 105 may be hosted on a separate server. For example, images may be hosted on a Google server as such; the computer device's 101, 101a, 101b, 101c web browser would then fetch this data from the Google server in order to render a valid webpage to the user 100.

A user 100 may submit valid parameters via a login provided by the website 102, to gain access to online profiles associated with the user 100. Valid parameters are bits of data submitted via a user form on the website 102, such as but not limited to username, password, etc., that have been validated by the server side program 107. Online profiles for the user 100 may be stored securely on the database 108 so that if the user 100 requests to navigate to a profile with a given uniform resource locator; for example, www.Facebook.com, he or she may be directed to the webpage associated with the uniform resource locator. An online profile includes any e-commerce, banking, music, e-mail, social media, gaming, etc., website that requires valid parameters (e.g., usernames and passwords, or other credentials) in order to attain access to the given functions of that website. The construction of the dynamic webpage and user interface is dependent on the user's preferences and may be specific to the user 100. The user may be directed to a new webpage if his or her browser is not equipped with an installable plug-in, which may allow the target webpage to be displayed in the current web browser window. A plug-in, also known as a browser extension or add-on is herein, defined as a computer program that extends the functionality of the web browser. The web browser may be comprised of a plug-in or add-on in order to enable a software developer the abilities to extend interaction and manipulation of the browser's Document Object Model (DOM) as specified in the browser's Application Programming Interface (API). There are various frameworks and programming languages that may be used to construct the plug-in, such as but not limited to C, C++, Java, PHP, Python, JavaScript, VBScript, etc. Different browsers require specific APIs to build plug-in's and different code and programming skills Therefore, there are various programming development frameworks that may be used which allow developers to build cross-browser plug-ins for Internet Explorer, Firefox, Chrome, Safari, Opera, etc.; these frameworks include but are not limited to Add-ons Framework and the Crossrider development framework. Furthermore, the plug-in may or may not be browser specific. The browser is configurable to execute a client side program 104 that calls upon a server side program 107 to automatically render valid parameters for www.Facebook.com, which have previously been stored on the database 108. According to an embodiment of the present invention, the user 100 will not be required to enter a username and password for his or her profile; this will be generated automatically for user 100 at each new instance of a requested profile corresponding to the uniform resource locator.

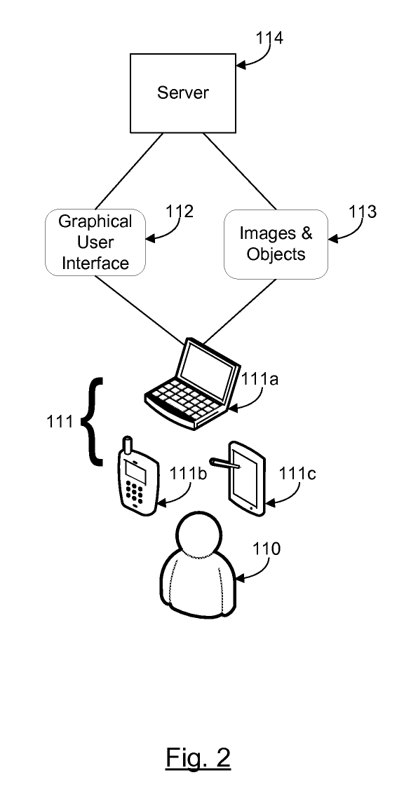

Referring to FIG. 2, according to a second embodiment of the invention, the system 140 disclosed herein includes at least one user 110 and a client computing device 111, including but not limited to a laptop computer 111a, a mobile device 111b, 111c such as a smart phone 111b or tablet 111c, etc. A client computing device 111, 111a, 111b, 111c may also have the capabilities to fetch, receive, and decode information from a server 114 via an internet protocol such as but not limited to hyper text transfer protocol (HTTP), File Transfer Protocol (FTP), Transfer Control Protocol and Internet Protocol (TCP/IP), etc.

The user interface 112 may further comprise images & objects 113, which includes other data such as but not limited to pictures, videos, sound files, arrays, instantiated objects, etc. An instantiated object is defined herein, as any memory storage location on the computing device 111, which has been designated by the programmer for purposes of supporting the development of the graphical user interface 112, and that supports the functionality of the present invention. For purposes of a more readily executable standalone program and graphical user interface 112, images & objects 113 may be stored on the local machine; however, this is subject to the architecture set forth by the web developer and these images & objects 113 may be hosted on a remote device, such as but not limited to a third party remote server 114, external memory storage devices, etc. For example, images may be hosted on a third party website located on a Google server as such; the standalone program would then fetch these objects from the Google server in order to render images for the graphical user interface. The user interface 112 can also be comprised of a dynamic or static webpage, both of which have been previously described herein.

Stored parameters, such as but not limited to passwords, usernames, etc., for the user's 110 online profiles can be stored securely on the computing device 111 so that if the user 110 requests to navigate to a profile with a given uniform resource locator; for example, www.Facebook.com, he or she may be directed to the target webpage. The target webpage may be displayed either in a web browser that is part of the standalone program or as a separate entity in it of itself, such as on the web browser of the computing device 111. As such, the user 110 will not be required to enter a username and password or some other access-granting parameter for his or her profile; this will be generated automatically for user 110 at each new instance of a requested profile.

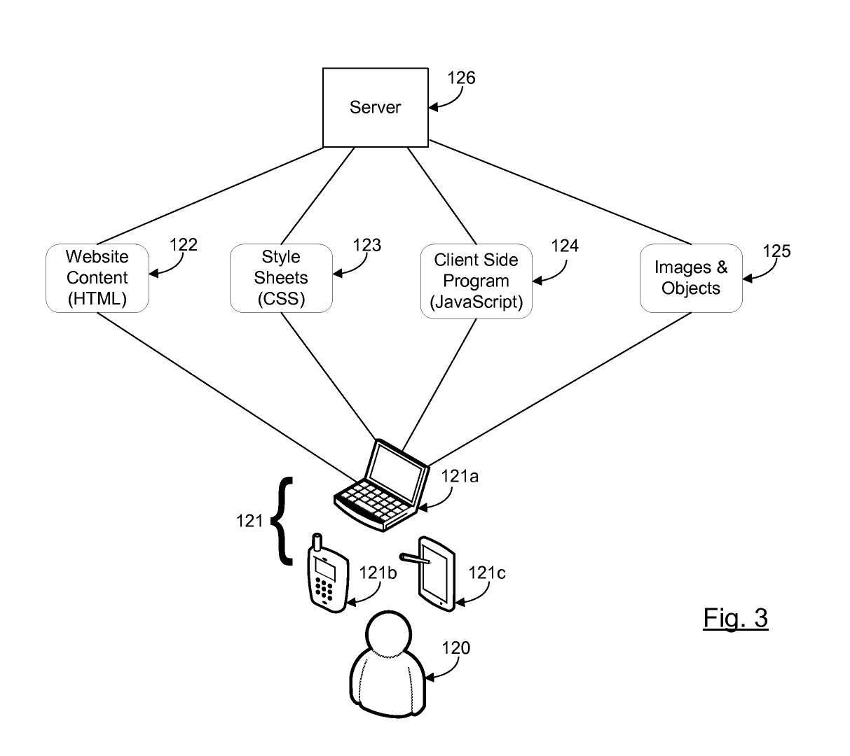

Referring to FIG. 3, according to a third embodiment of the invention, the system 150 disclosed herein includes at least one user 120 and a client computing device 121, including but not limited to a laptop computer 121a, a mobile device 121b, 121c such as a smart phone 121b or tablet 121c, etc. A client computing device 121 in this context is any physical object containing a microprocessor and a memory device with the capability to access the internet through means of a browser, whether the browser is a standalone browser or a larger program that includes a browser. A client computing device 121, 121a, 121b, 121c may also have the capabilities to fetch, receive, and decode information from a server 126 via an internet protocol such as but not limited to hyper text transfer protocol (HTTP), File Transfer Protocol (FTP), Transfer Control Protocol and Internet Protocol (TCP/IP), etc.

A server 126 may host a client side program 124 in which the client computer 121, 121a, 121b, 121c may request in order for the user 120 to access all of his or her online profiles. A request is made to the server 126 by the web browser of the client computer 121, 121a, 121b, 121c; this request is submitted via a user form that can be accessed by the client computer 121, 121a, 121b, 121c by means of a website with a specific uniform resource locator. The website 122 in context may be hosted on a server 126. On request by the web browser of the client computer 121, 121a, 121b, 121c to the server 126 via a user form on the website 122, a client side program 124 may work to validate the submitted user form. There are many Client Side Programming languages that may be used, such as but not limited to JavaScript, VBScript, PerlScript, etc. Upon validation of the parameters submitted within the user form, the client side program 124 may retrieve the user's 120 specific information which may be stored within instantiated objects within the client side program 124. Depending on the architecture of the web developer, it is also important to note that the client side program 124 and the website 122 themselves may also reside on the local machine and not necessarily on the server 126.

A user interface is made available via a website 122, which is hosted by a server 126. The user interface is comprised of a markup language which may include but is not limited to a hyper text markup language, such as but not limited to HTML, XML, XHTML, WML, DHTML, etc. The markup language may serve to provide structure for the given elements that compose the website 122, while a style sheet language such as but not limited to Cascading Style Sheets (CSS), Document Style and Semantics and Specification Language (DSSL), Extensible Style sheet Language (XSL), JavaScript Style Sheets (JSSS), etc., style sheets 123 may provide the website 122 with the formatting of these various elements. A client side program 124 comprised of but not limited to JavaScript, VBScript, PerlScript, etc. may serve to enhance user interactivity via the website 122. Source code for the markup language, style sheets 123, and client side program 124 may be hosted on at least one server 126, presented via the means of a website, and executed on the client computer 121, 121a, 121b, 121c web browser. The user interface may be comprised of a static webpage; of which has been previously described herein.

Images & objects 125 include other data comprised of pictures, videos, sound files, etc., that support the construction of the website 122. For purposes of a more readily available webpage, images & objects 125 may be stored on the same host server 126 as the client side program 124; however, this is subject to the architecture set forth by the web developer and these images & objects 125 may be hosted on a separate server.

Once a user 120 has submitted valid parameters via a login provided by the website 122, then the user 120 is given instant access to all of his or her online profiles. The construction of the dynamic webpage and user interface is dependent on the user's preferences and may be specific to the user 120. Stored passwords and usernames for the user's 120 profiles may be stored securely within the client side program 124 so that if the user 120 may request to navigate to a profile with a given uniform resource locator; for example, www.Facebook.com, he or she may be directed to the new webpage. The user may be directed to a new webpage if his or her browser is not equipped with an installable plug-in, which may allow the target webpage to be displayed in the current web browser window. The web browser may be comprised of a plug-in for reasons of which have been previously described herein. The browser will execute a client side program 124 to automatically return valid parameters for www.Facebook.com, for instance, which has previously been stored within the client side program 124. As such, the user 120 will not be required to enter a username and password or some other access-granting parameter for his or her profile; this will be generated automatically for him or her at each new instance of a requested profile. Generally referring to FIGS. 1 through 3, each of the above embodiments 130, 140, 150 can be directly or indirectly, optionally embeddable, in another website.

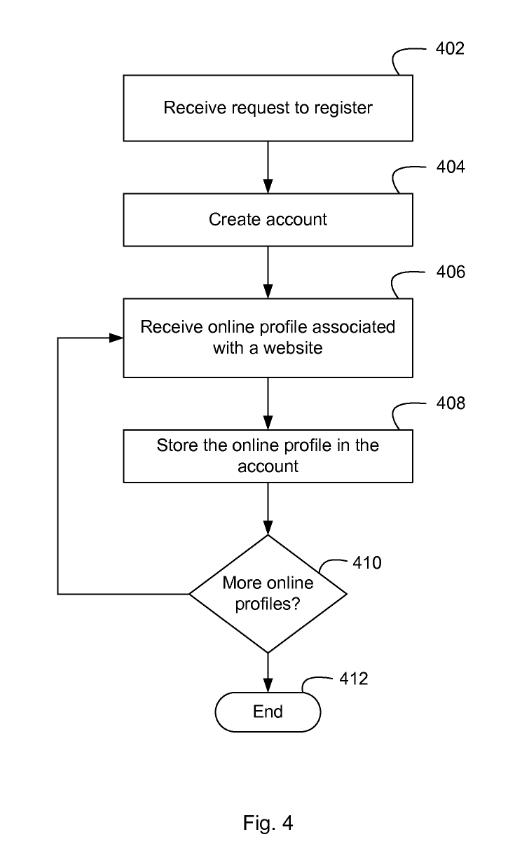

FIG. 4 presents a flowchart of a method for storing online profiles associated with a plurality of websites according to an embodiment of the present invention. A server hosting a website for storing user online profiles receives a request to register for a user account, step 402. The request may be received at the website or program server from a device with a microprocessor and with web browsing capabilities via an internet protocol; may it be hyper text transfer protocol or some other. Receiving a request to register may include receiving login parameters (e.g., a username and password) from a registering user. The user account is created, step 404. Upon creation of the account, the user may store online profiles for one or more websites on the server. As an example, the online profiles may include usernames and passwords associated with specific uniform resource locators or websites.

The website or program may provide the user with links to any of an unlimited number of target websites. The user can selectively choose target websites or links to target websites he or she may choose to interface with on the website or program by entering his or her profile information and activating said link or target websites. As such, the entered profile information may be linked or associated with a selected website. An online profile associated with a website is received, step 406. Receiving the online profile includes, for example, receiving a username and password in association with a specific website or uniform resource locator. The online profile is stored in the account of the user, step 408. A plurality of online profiles may be submitted by a user. If the user desires to store additional profiles, step 410, another profile associated with a website is received in step 406. In an alternative embodiment, the user may be allowed to store a plurality of user profiles for a given web site in a single user account. Once the user has completed submitting profiles to their account, step 412, the user may access their stored online profiles at any given time from the account.

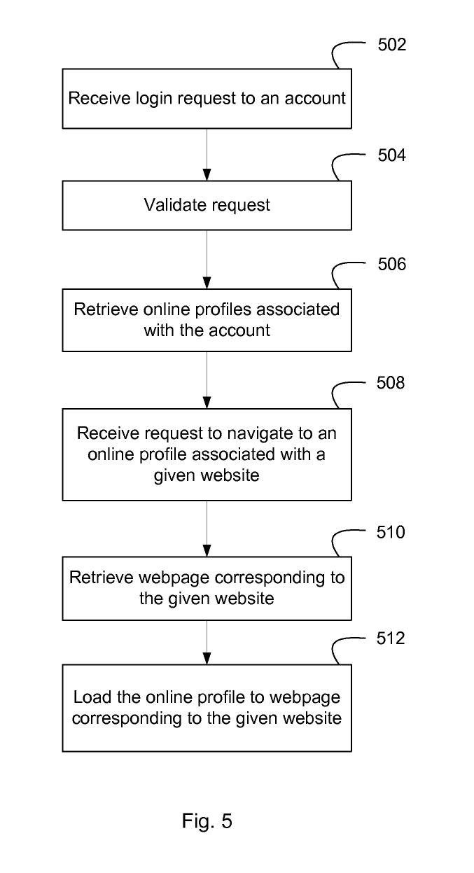

FIG. 5 presents a flowchart of a method for loading online profiles according to an embodiment of the present invention. A login request is received for accessing user online profiles, step 502. The login request may include receiving valid parameters from a user via a login provided by a website to gain access to online profiles associated with the user. Upon fulfillment of this request, and using a hypertext markup language construct, the web browser may present a login comprised of a username and a password. Upon submittal of the user form information, a server side program will send the given parameters to a database platform which will in turn validate the information that has been submitted.

The request is validated by the website to gain access to a user account, step 504. Valid parameters are bits of data submitted via a user form on the website, such as but not limited to username, password, etc., that have been validated by the server side. Once validation has been completed a user will have instant access to all of his or her online profiles. Usernames and passwords for various profiles submitted and stored by the user may be retrieved via a server side program when requested by the browser. In at least one embodiment, the system can also be accomplished by means of a computer programming language in which algorithms construct a standalone program capable of storing, fetching, and receiving a user's online profile(s).

Online profiles associated with the account are retrieved, step 506. The online profiles may be retrieved and displayed to the user. A request is received from the user to navigate to an online profile associated with a given website, step 508. A webpage corresponding to the given website is retrieved, step 510. Retrieving the webpage may include directing the user to the webpage associated with a uniform resource locator of the given website. At the request of a profile and its website and depending on whether or not the user has a web browser plug-in or standalone program containing a web browser, the user will either be directed to another webpage while still signed into the website or program server or the browser's target may be the current window. Upon retrieving the webpage, the online profile is automatically loaded to the webpage corresponding to the given website, step 512. The website or program populates the user's stored passwords automatically as a browser calls on a target website(s). The user accesses the website or program with the loaded username and password, either automatically by the website or manually (e.g., the user makes a selection, click, or press to login with the loaded username and password).

It is stated now expressly and implied herein that the invention disclosed herein, including all embodiments, is meant to be illustrative rather than exhaustive: that the elements used to construct such a system(s) may vary primarily due to the multitude of different system architectures, computer programming languages, etc., that may viably and variably be implemented to accomplish the same. However, the integrity of this invention, as described herein, lies in the fundamental elements described herein such that these elements cooperate together as a system(s) that stores a user's relevant parameters for any given online profile that the user requests access to and grants the user access to said profile, obviating the need for the user to have to remember and enter in each and every parameter for each and every website he or she wishes to access from any computing devices, not just personal devices, from anywhere in the world. Such a system may not only serve to simplify users' online profiles, but also improve a user's overall browsing experience.

FIGS. 1 through 5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for managing online profiles, the method comprising:
receiving a plurality of online profiles of a user, the plurality of online profiles including login parameters for websites;
storing the plurality of online profiles in an account associated with the user;
receiving a request to navigate to a given one of the plurality of online profiles associated with a given website;
retrieving a webpage corresponding to the given website; and
loading the given online profile to the webpage corresponding to the given website.

2. The method of claim 1 wherein receiving the plurality of online profiles includes receiving usernames and passwords for specific websites.

3. The method of claim 1 further comprises providing a plurality of websites to link with the login parameters.

4. The method of claim 1 wherein loading the given online profile to the webpage includes populating login parameters from the given online profile to the webpage.

5. A system for managing online profiles, the system comprising:
a processor; and
a memory having executable instructions stored thereon that when executed by the processor cause the processor to:
receive a plurality of online profiles of a user, the plurality of online profiles including login parameters for websites;
store the plurality of online profiles in an account associated with the user;
receive a request to navigate to a given one of the plurality of online profiles associated with a given website;
retrieve a webpage corresponding to the given website; and
load the given online profile to the webpage corresponding to the given website.

6. The system of claim 5 wherein the processor is configured to receive usernames and passwords for specific websites.

7. The system of claim 5 wherein the processor is configured to provide a plurality of websites to link with the login parameters.

8. The system of claim 5 wherein the processor is configured to populate login parameters from the given online profile to the webpage.

9. Non-transitory computer readable media comprising program code that when executed by a programmable processor causes execution of a method for managing online profiles, the computer readable media comprising:
computer program code for receiving a plurality of online profiles of a user, the plurality of online profiles including login parameters for websites;
computer program code for storing the plurality of online profiles in an account associated with the user;
computer program code for receiving a request to navigate to a given one of the plurality of online profiles associated with a given website;
computer program code for retrieving a webpage corresponding to the given website; and
computer program code for loading the given online profile to the webpage corresponding to the given website.

10. The computer readable media of claim 9 wherein the computer program code for receiving the plurality of online profiles includes computer program code for receiving usernames and passwords for specific websites.

11. The computer readable media of claim 9 further comprises computer program code for providing a plurality of websites to link with the login parameters.

12. The computer readable media of claim 9 wherein the computer program code for loading the given online profile to the webpage includes computer program code for populating login parameters from the given online profile to the webpage.
